(19) United States
(12) Patent Application Publication
(10) Pub. No.: US 2019/0077635 A1
(43) Pub. Date: Mar. 14, 2019

(54) ELEVATOR CARRIAGE HANDLING ARRANGEMENT

(71) Applicant: ARTICULATED FUNICULATOR AB, Stockholm (SE)

(72) Inventor: Fritz KING, Stockholm (SE)

(21) Appl. No.: 15/743,078

(22) PCT Filed: Jun. 28, 2016
(86) PCT No.: PCT/SE2016/050641

§ 371 Date: Jan. 9, 2018

(30) Foreign Application Priority Data
Jul. 10, 2015 (SE) 1551012-6

(51) Int. Cl. B66B 9/00; B66B 9/10

(52) U.S. Cl. CPC B66B 9/003; B66B 7/021; B66B 9/10

(57) ABSTRACT

Arrangement (10) for handling carriages (12) in an elevator system (42), the arrangement (10) comprising at least one carriage (12); a storage area (14) adjacent to an operational path (20) of the elevator system (42) for storage, service and/or maintenance of the at least one carriage (12); and a transfer mechanism (16) for transferring the carriage (12) between an operational position (24) along the operational path (20) and at least one storage position (26) within the storage area (14).

### TECHNICAL FIELD

The present disclosure generally relates to an arrangement for handling elevator carriages. In particular, an arrangement for handling carriages in an elevator system and an elevator system comprising the arrangement are provided.

### BACKGROUND

Various types of elevator systems for vertically transporting people and/or goods are known. Some elevator systems drive a plurality of carriages along the same path, e.g. with a single driving cable.

The Articulated Funiculator (R) is a new concept of vertical transportation which is described in WO 2013159800 A1. With this concept, several trains of carriages (train cars) traverse between stations separated by a large distance of, for example, 100 meters.

In elevator systems where several carriages travel along a common path, the entire elevator system often needs to be stopped for maintenance and service of the carriages. In case a large number of carriages are present in the system, these stops become more frequent.

### SUMMARY

Accordingly, one object of the present disclosure is to provide a simple arrangement for handling carriages in an elevator system that can quickly and easily add and/or remove a carriage from an operational path for efficient storage, service and/or maintenance.

According to one aspect, an arrangement for handling carriages in an elevator system is provided, where the arrangement comprises at least one carriage; a storage area adjacent to an operational path of the elevator system for storage, service and/or maintenance of the at least one carriage; and a transfer mechanism for transferring the carriage between an operational position along the operational path and at least one storage position within the storage area. The arrangement according to the present disclosure enables simple and fast addition and removal of carriages to and from the operational path.

The carriage may be a passenger carriage and/or a load carriage. The carriage may alternatively be referred to as a pod, cabin or car. Several carriages may be used in the elevator system. The carriages may be individually routed on the operational path or collectively as trains with two or more carriages. In case the carriages are driven collectively as trains, the carriages may be driven individually or interconnected, for example with cables.

The arrangement according to the present disclosure is not limited to any particular type of propulsion system. For example, all carriages in the elevator system may be driven with a cable or set of cables or each carriage may have an individual propulsion system. Two or more different types of propulsion systems may also be combined within the elevator system.

The storage area may be provided on a floor or may be constituted by a floor. The storage area may comprise a storage with two or more vertically separated layers or planes where each plane comprises one or more storage positions. Alternatively, the storage area may be constituted by a truck. The storage area is thus adjacent to, but separated from, the operational path.

The operational path may be constituted by a track in the elevator system. The track may include a single or several rails. One suitable track is constituted by a pair of rails. Each carriage may thus comprise at least one wheel assembly for engaging a rail portion of the track to establish the movement along the track. However, each carriage may alternatively be driven along the operational path, e.g. with linear electric motors. In this case, rails may be omitted.

The storage area may comprise a plurality of storage positions, such as four or more storage positions. In case a plurality of storage positions are present in the storage area, the transfer mechanism may be configured to transfer a carriages between the operational position and each available storage position (i.e. where no carriage is present), regardless of how many of the remaining storage positions are occupied. For this purpose, the storage area may include storage positions in a circular layout.

In case the carriages are moved to the storage area merely for storage, the carriages may be placed immediately adjacent to each other. In case service and/or maintenance is intended to be carried out on a carriage, a sufficient spacing may be provided around this carriage. Thus, the layout of the storage positions within the storage area may be altered in case service and/or maintenance is to be carried out in addition to storage.

The transfer mechanism may comprise a robot for moving the carriage to and from the storage position. The robot may be constituted by a conventional industrial robot dimensioned to handle the load of a carriage. The robot may have six degrees of freedom. Two or more robots for moving the carriage to and from the storage position may be provided. The robot may have a stationary base. Alternatively, the robot may be movably arranged in one or more horizontal directions. Thus, the storage area may comprise two subareas along and on opposite sides of a direction of movement of the robot base.

The robot may be configured to move the carriage between the operational position and the storage position. Thereby, the transfer mechanism may be entirely constituted by the robot. The robot may be positioned and dimensioned such that it can reach a carriage at the operational position, lift the carriage from the operational path and move the carriage to a storage position (and vice versa).

The transfer mechanism may comprise a track section for guiding the carriage between the operational position and the storage position. The track section may comprise a pair of rails. In this case, the carriage may comprise at least one wheel assembly engaging each rail. The carriage may be driven along the track section with its propulsion system (e.g. a linear motor). Alternatively, a service propulsion system may be provided on the carriage (e.g. merely dimensioned for horizontal travel). The carriage could also be pushed manually along the track section.

The track section may comprise a turntable. The turntable may comprise a pair of rails such that the carriage can roll onto and off the turntable. In case the turntable is provided in combination with a storage area having two or more vertically separated layers, the turntable may be vertically adjustable between the layers. Any suitable mechanism for raising or lowering the turntable may be used, for example a hydraulic lift.

At least a part of the track section may be movable between a switching state for guiding the carriage to the storage position and an operational state where the track section forms a part of the operational path. For example, a movable part of the track section may be moved to the switching state where the carriage can be guided to one or more further stationary track sections for guiding the carriage to the storage positions. Alternatively, the entire track section may be movable between the switching state and the operational state.

The transfer mechanism may comprise a track section for guiding the carriage to an intermediate position from which the robot can move the carriage to and from the storage position. In this case, the robot does not have to be dimensioned and/or placed such that it can reach the operational position.

At least a part of the track section may be movable between a switching state constituting the intermediate position or for guiding the carriage to the intermediate position and an operational state where the track section forms a part of the operational path. For example, in case a part of the track section is movable to a switching state constituting the intermediate position, the movable part of the track section can be made relatively short, e.g. just sufficient to support one carriage. In case a part of the track section is movable to a switching state for guiding the carriage to the intermediate position, the movable part of the track section can first be moved and then the carriage can be moved off the movable part to a stationary part of the track section from where it can be guided to the intermediate position.

The carriage may comprise at least one openable wheel assembly that in an open state enables the carriage to be lifted off a track by a robot and in a closed state locks the carriage to the track for relative movement thereon. According to one variant, the carriage comprises four openable wheel assemblies, where two pairs are adapted to engage different rails. The opening and closing of the at least one openable wheel assembly may be electronically controlled. Alternatively, the opening and closing may be mechanically controlled and for example activated by the robot.

According to a further aspect, there is provided an elevator system comprising an arrangement according to the present disclosure. The elevator system may be provided in an elevator shaft within a building and/or be provided at the exterior of the building. The elevator system may also be provided in an underground shaft to serve one or more underground stations or a deep mine. The arrangement may be provided at an upper or lower level or at any position along an operational path of the elevator system.

According to a further aspect, there is provided a carriage for an elevator system, wherein the carriage comprises at least one openable wheel assembly that in an open state enables the carriage to be lifted off a track by a robot and in a closed state locks the carriage to the track for relative movement thereon.

Some exemplary variants are here presented as items:
1. Arrangement for handling carriages in an elevator system, the arrangement comprising:
   at least one carriage;
   a storage area adjacent to an operational path of the elevator system for storage, service and/or maintenance of the at least one carriage; and
   a transfer mechanism for transferring the carriage between an operational position along the operational path and at least one storage position within the storage area.
2. The arrangement according to item 1, wherein the transfer mechanism comprises a robot for moving the carriage to and from the storage position.
3. The arrangement according to item 2, wherein the robot is configured to move the carriage between the operational position and the storage position.
4. The arrangement according to item 1, wherein the transfer mechanism comprises a track section for guiding the carriage between the operational position and the storage position.
5. The arrangement according to item 4, wherein the track section comprises a turntable.
6. The arrangement according to item 4 or 5, wherein at least a part of the track section is movable between a switching state for guiding the carriage to the storage position and an operational state where the track section forms a part of the operational path.
7. The arrangement according to item 2, wherein the transfer mechanism comprises a track section for guiding the carriage to an intermediate position from which the robot can move the carriage to and from the storage position.
8. The arrangement according to item 7, wherein at least a part of the track section is movable between a switching state constituting the intermediate position or for guiding the carriage to the intermediate position and an operational state where the track section forms a part of the operational path.
9. The arrangement according to any of the preceding items, wherein the carriage comprises at least one openable wheel assembly that in an open state enables the carriage to be lifted off a track by a robot and in a closed state locks the carriage to the track for relative movement thereon.
10. Elevator system comprising an arrangement according to any of the preceding items.

### BRIEF DESCRIPTION OF THE DRAWINGS

Further details, advantages and aspects of the present disclosure will become apparent from the following embodiments taken in conjunction with the drawings, wherein:

FIG. 1: schematically represents a carriage handling arrangement comprising a storage area and a robot;

FIG. 2: schematically represents a carriage handling arrangement comprising a storage area, a robot and a movable track section;

FIG. 3: schematically represents a carriage handling arrangement comprising a storage area, a robot and a stationary track section;

FIG. 4: schematically represents a carriage handling arrangement comprising a storage area and stationary track section;

FIG. 5: schematically represents a carriage handling arrangement comprising a storage area and a movable track section;

FIG. 6: schematically represents a carriage handling arrangement comprising a storage area and a track section with a turntable; and

FIG. 7 schematically represents a perspective partial view of an elevator system comprising a carriage handling arrangement of the type in FIG. 1.

### DETAILED DESCRIPTION

In the following, an arrangement for handling carriages in an elevator system and an elevator system comprising the arrangement will be described. The same reference numerals will be used to denote the same or similar structural features.

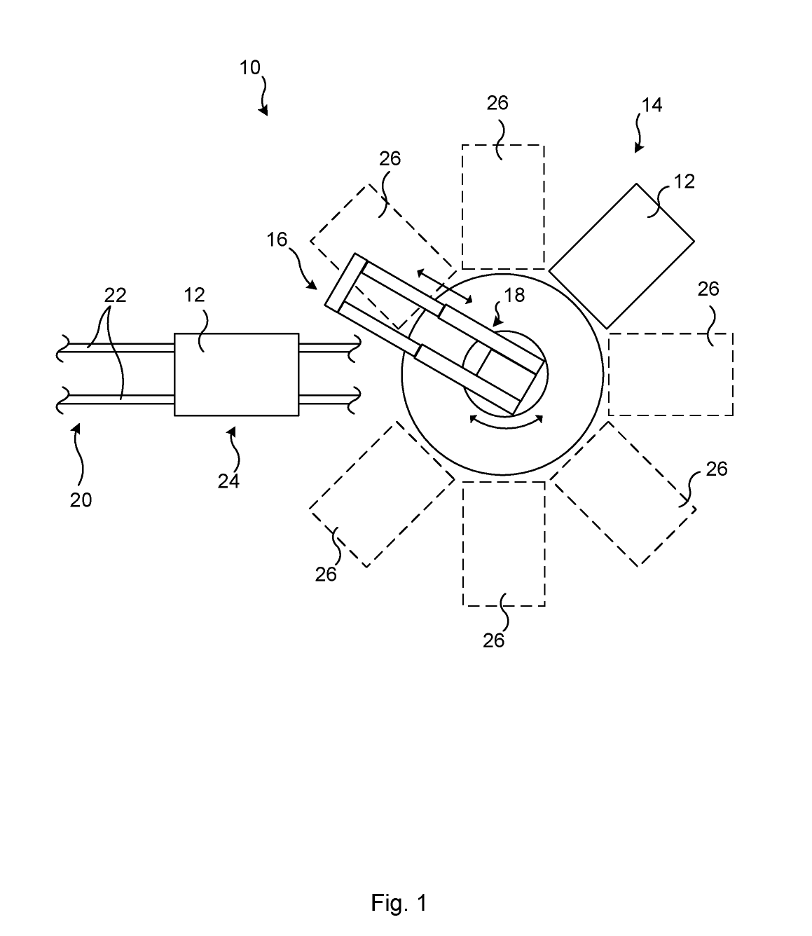

FIG. 1 schematically represents an arrangement 10 for handling carriages 12 in an elevator system. The arrangement 10 comprises a storage area 14 and a transfer mechanism 16 in the form of a robot 18.

In FIG. 1, a part of an upper loop of an operational path 20 of the elevator system is shown. The operational path 20 in this embodiment comprises a track with two rails 22 which can be engaged by wheel assemblies (not shown) on the carriages 12 for relative movement thereon. The arrangement 10 is arranged adjacent to an upper floor of a building (not shown).

In FIG. 1, one carriage 12 is provided at an operational position 24 along the operational path 20 and one carriage 12 is provided at a storage position 26 in the storage area 14. The carriages 12 are passenger carriages. The operational position 24 is a position through which the carriage 12 passes during its normal operation in the elevator system when transporting passengers.

The storage area 14 is implemented as a plurality (seven in FIG. 1) of storage positions 26 in a circular layout around the base of the robot 18. The storage area 14 is arranged adjacent to the operational path 20. In FIG. 1, the storage area 14 is provided substantially at the same plane as the illustrated horizontal portion of the operational path 20.

Due to the circular layout of the storage area 14, a spacing is established between each two storage positions 26 and consequently also between carriages 12 placed thereon. Thereby, in addition to storage, space is provided around the carriages 12 for necessary maintenance and/or repair.

The robot 18 is here a conventional industrial robot. The robot 18 is configured to move the carriage 12 to and from each storage position 26. More specifically, the robot 18 is configured to lift the carriage 12 at the operational position 24 and position the carriage 12 at a vacant storage position 26. The robot 18 is also configured to carry out a reverse procedure, i.e. to transfer a carriage 12 from any of the storage positions 26 to the operational position 24. Thus, in FIG. 1, the entire transfer mechanism 16 is constituted by the robot 18.

The robot 18 may include a telescoping arm such that it can rotate with a reduced radial extension. Thereby, the storage positions 26 can be arranged relatively close to the robot 18. Alternatively, the robot 18 may adopt a raised state when rotating around an axis substantially normal to a plane including the storage positions 26 such that a gripping end of the robot 18 is above carriages 12 in the storage area 14.

Various methods for monitoring which storage positions 26 are occupied or vacant may be used. This may be “remembered” by the robot 18 or by an overall control system for the elevator system. Alternatively, sensors may be used. It is also conceivable to employ a manual handling, e.g. by a manual control of the robot 18.

Openable wheel assemblies may be used on the carriages 12 such that the carriages 12 can be engaged with and released from the rails 22. These wheel assemblies may be mechanically or electrically controlled.

The operational position 24 may be a position at a station where one or more carriages 12 stop to allow passengers to enter and leave the carriages 12. The carriage 12 may be lifted away from the operational path 20 or added thereto during one stop cycle at a station. Thereby, the flow of a train with several carriages 12 in the elevator system may not be affected. However, the operational position 24 may be at any portion along the operational path 20 such as between two stations served by the elevator system.

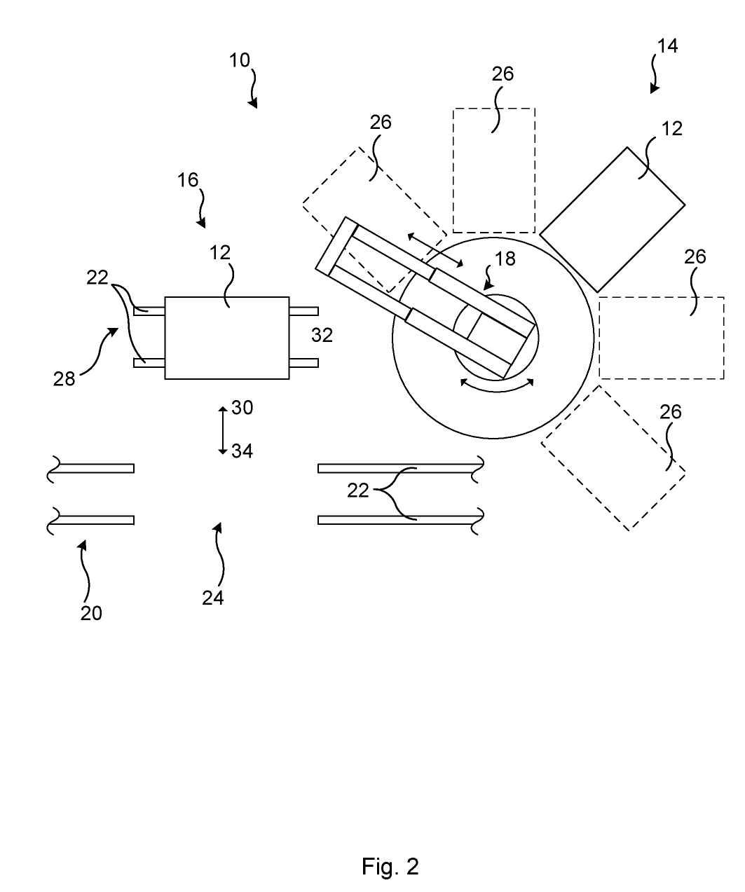

FIG. 2 schematically represents a further arrangement 10 for handling carriages 12 in an elevator system. Mainly differences with respect to FIG. 1 will be described.

The arrangement 10 in FIG. 2 comprises a storage area 14 and a transfer mechanism 16 in the form of a robot 18 and a movable track section 28.

The movable track section 28 has a pair of rails 22 corresponding to the rails 22 in the operational path 20. In FIG. 2, the track section 28 comprises a track length slightly longer than the size of the carriage 12.

The track section 28 is movable between a switching state 30 constituting an intermediate position 32 and an operational state 34 where the track section 28 forms a part of the operational path 20. Any type of drive may be used for moving the track section 28 between the operational state 34 and the switching state 30. FIG. 2 illustrates the track section 28 in the switching state 30 where it constitutes the intermediate position 32.

When the track section 28 is in the operational state 34 and constitutes a part of the operational path 20, a carriage 12 can be stopped on the track section 28. When a carriage 12 has stopped on the track section 28, the track section 28 can be moved from the operational state 34 to the switching state 30.

In the switching state 30 of the track section 28, the carriage 12 is positioned at an intermediate position 32 from which the robot 18 can move the carriage 12 to storage positions 26 in the storage area 14. The robot 18 is capable to move the carriage 12 from the intermediate position 32 to each available storage position 26 in the storage area 14.

When a carriage 12 at any of the storage positions 26 in the storage area 14 is to be added to the operational path 20, a reverse procedure is carried out. Thus, the carriage 12 is moved by the robot 18 from a storage position 26 to the intermediate position 32 and the track section 28 is then driven from the switching state 30 to the operational state 34 where the track section 28 constitutes a part of the operational path 20.

At the times when no carriage 12 is present on the movable track section 28, the track section 28 may be placed in the operational state 34 such that carriages 12 can bypass the arrangement 10 along the operational path 20.

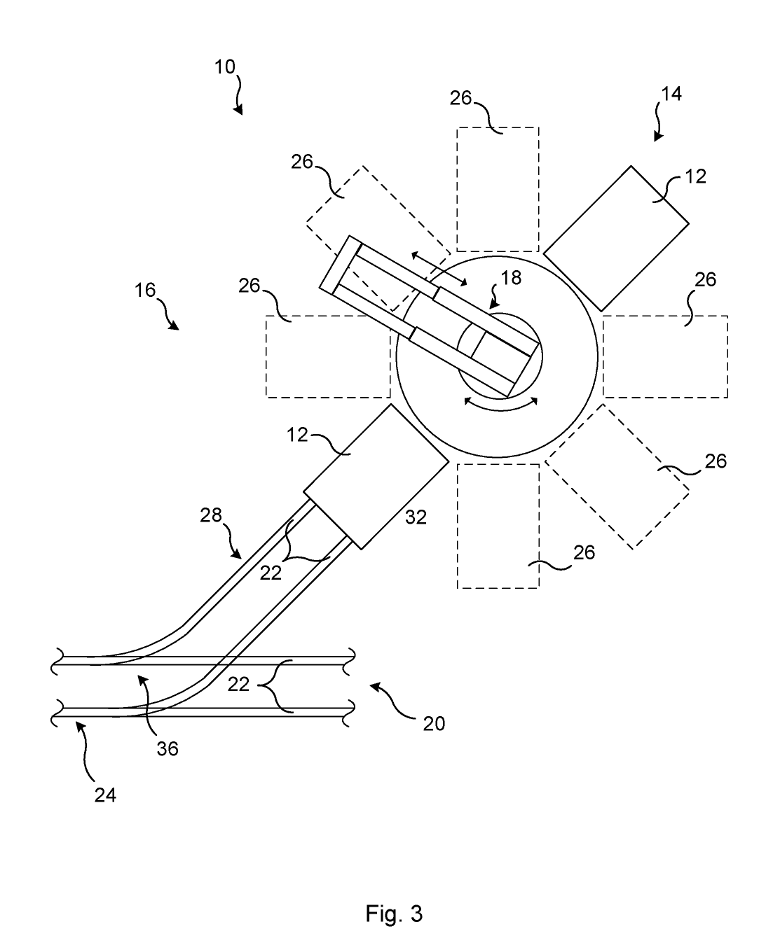

FIG. 3 schematically represents a further arrangement 10 for handling carriages 12 in an elevator system. Mainly differences with respect to the preceding figures will be described.

The arrangement 10 in FIG. 3 comprises a storage area 14 and a transfer mechanism 16 in the form of a robot 18 and a stationary track section 28. The arrangement 10 comprises a switching mechanism 36 for guiding carriages 12 on the operational path 20 either to bypass the track section 28 (passive state) or to enter the track section 28 (active state). The switching mechanism 36 may adopt various configurations for this purpose. For example, the switching mechanism 36 may be a railroad switch.

When the switching mechanism 36 is positioned in the active state (such that a carriage 12 can move from an operational position 24 along the operational path 20 and onto the track section 28), the carriage 12 can be moved from the operational position 24 and to an intermediate position 32 on the track section 28. This movement may for example be realized by an ordinary drive of the carriage 12, by a supplementary drive of the carriage 12 or by manually pushing or pulling the carriage 12. Once the carriage 12 has entered the track section 28, the switching mechanism 36 is placed in the passive state so that further carriages 12 can bypass the arrangement 10 along the operational path 20.

At the intermediate position 32, the robot 18 can grab the carriage 12 and move the carriage 12 to any vacant storage position 26 in the storage area 14. A reverse procedure is carried out for moving a carriage 12 from a storage position 26 to the operational position 24 on the operational path 20. The switching mechanism 36 is then put in the passive state such that the carriage 12 can continue along the operational path 20.

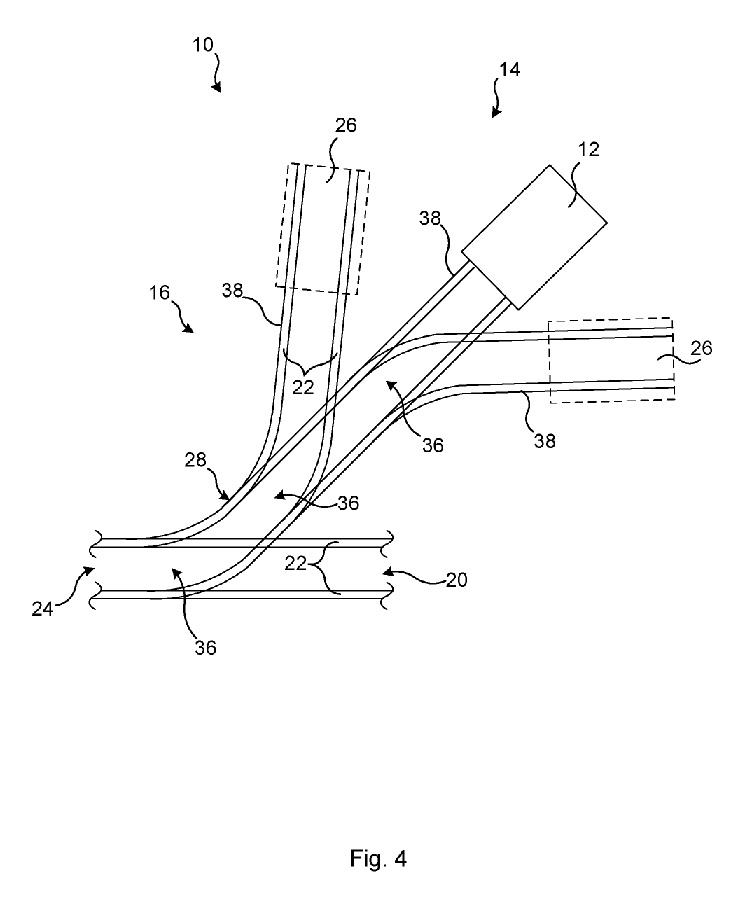

FIG. 4 schematically represents a further arrangement 10 for handling carriages 12 in an elevator system. Mainly differences with respect to the preceding figures will be described.

The arrangement 10 in FIG. 4 comprises a storage area 14 and a transfer mechanism 16 in the form of a track section 28 with a plurality of branches 38 (three in FIG. 4), each terminating in a storage position 26. One switching mechanism 36 is provided to guide carriages 12 on the operational path 20 either to bypass the track section 28 or to enter the track section 28. Two further switching mechanisms 36 are also provided for the three branches 38. The switching mechanisms 36 may be of the same type as in FIG. 3.

Thus, by placing the switching mechanisms 36 in a particular combination of states, a carriage 12 can be guided from the operational position 24 to any available storage position 26 along the track section 28 (and in the reverse direction).

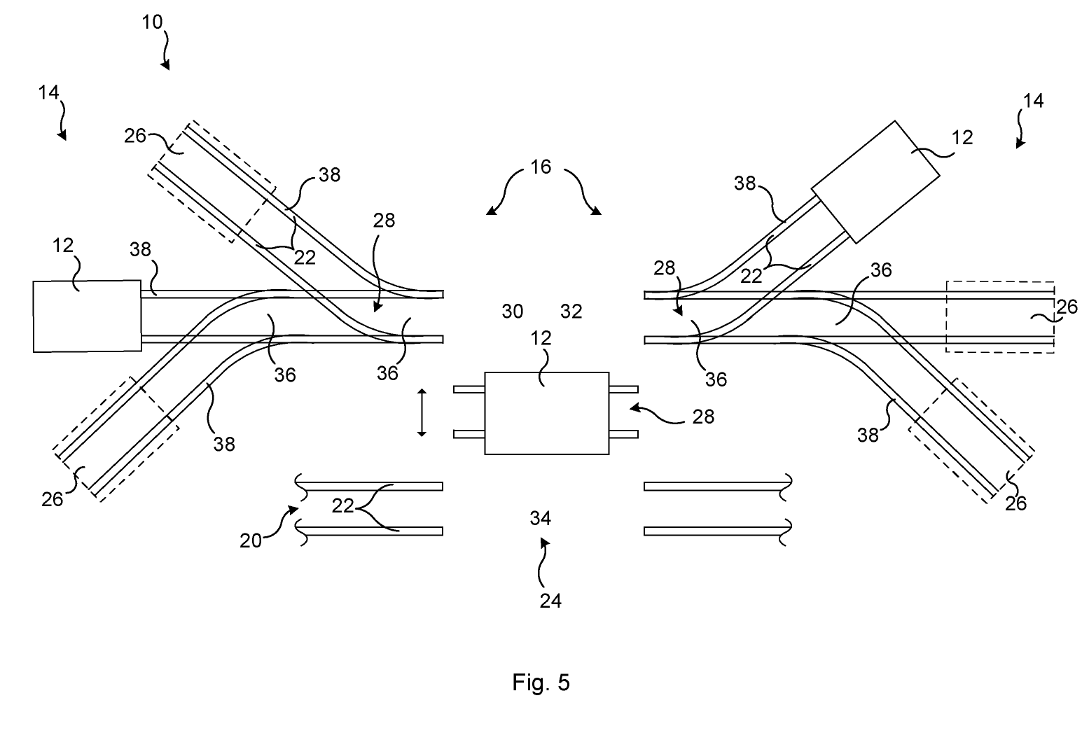

FIG. 5 schematically represents a further arrangement 10 for handling carriages 12 in an elevator system. Mainly differences with respect to the preceding figures will be described.

The arrangement 10 in FIG. 5 comprises a storage area 14 with two subareas and a transfer mechanism 16 in the form of a track section 28 with movable part and two stationary parts. The stationary parts have a plurality of branches 38 each terminating in a storage position 26.

The movable track section 28 is of the same type as in FIG. 2. Thus, the movable track section 28 is movable between an operational state 34 where the movable track section 28 forms a part of the operational path 20 and a switching state 30. In the switching state 30, the movable track section 28 is in an intermediate position 32 from which the carriage 12 can be moved to any of the two stationary track sections 28.

Thus, in case the movable track section 28 is positioned in the operational state 34, a carriage 12 can be positioned in the operational position 24 on the movable track section 28. The track section 28 with the carriage 12 thereon can then be moved from the operational state 34 to the switching state 30 where the carriage 12 is in the intermediate position 32. From the intermediate position 32, the carriage 12 can be moved to any available storage position 26 by placing the switching mechanisms 36 of the relevant subarea within the storage area 14 in corresponding states.

A reverse procedure may be used for moving a carriage 12 from any of the storage positions 26 to the operational position 24.

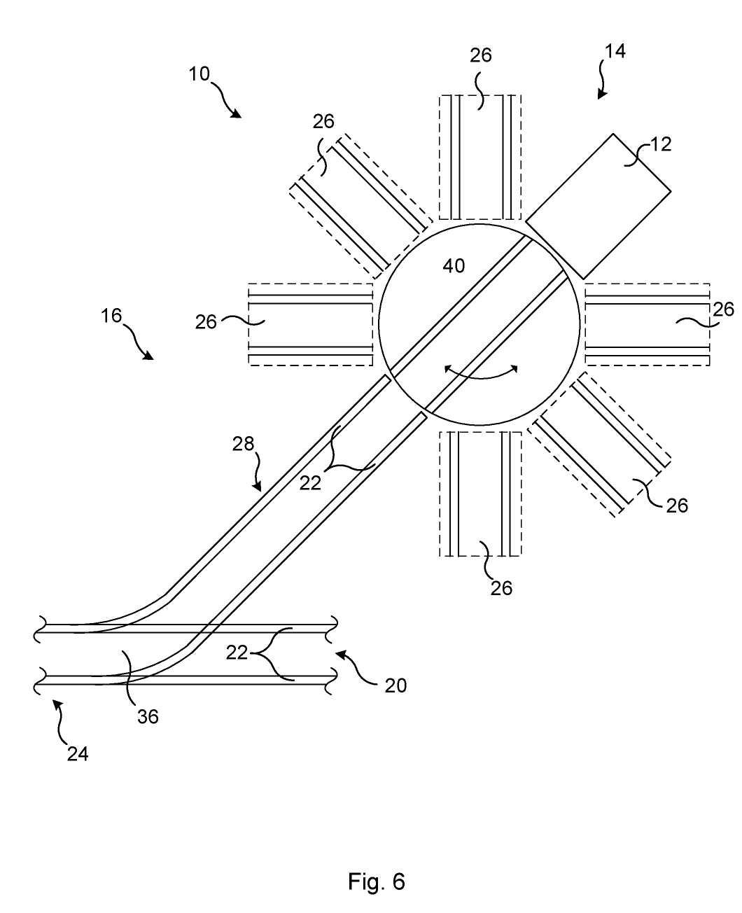

FIG. 6 schematically represents a further arrangement 10 for handling carriages 12 in an elevator system. Mainly differences with respect to the preceding figures will be described.

The arrangement 10 in FIG. 6 comprises a storage area 14 and a transfer mechanism 16 in the form of a track section 28 with a turntable 40. The track section 28 comprises a stationary part and a switching mechanism 36 for allowing carriages 12 to enter the stationary part of the track section 28 from an operational position 24 along the operational path 20 and for allowing carriages 12 to bypass the arrangement 10 along the operational path 20. The turntable 40 may be of a similar type as used for railroads.

Thus, by positioning the turntable 40 in a particular rotatable orientation, a carriage 12 on the stationary part of the track section 28 can be moved onto the turntable 40. The turntable 40 may also comprise a pair of rails 22 similar to the rails 22 on the stationary track section 28. Once the carriage 12 is on the turntable 40, the turntable 40 can be rotated to a number of rotational positions such that the carriage 12 can be moved off the turntable 40 and into a storage position 26. Each storage position 26, e.g. a portion on the floor, also comprises a pair of rails 22 similar to the rails 22 on the stationary track section 28.

The turntable 40 may also be raised and/or lowered to access a further set of storage positions 26 similar to the ones illustrated in FIG. 6. A reverse procedure may be used to move a carriage 12 from any of the storage positions 26 to the operational position 24.

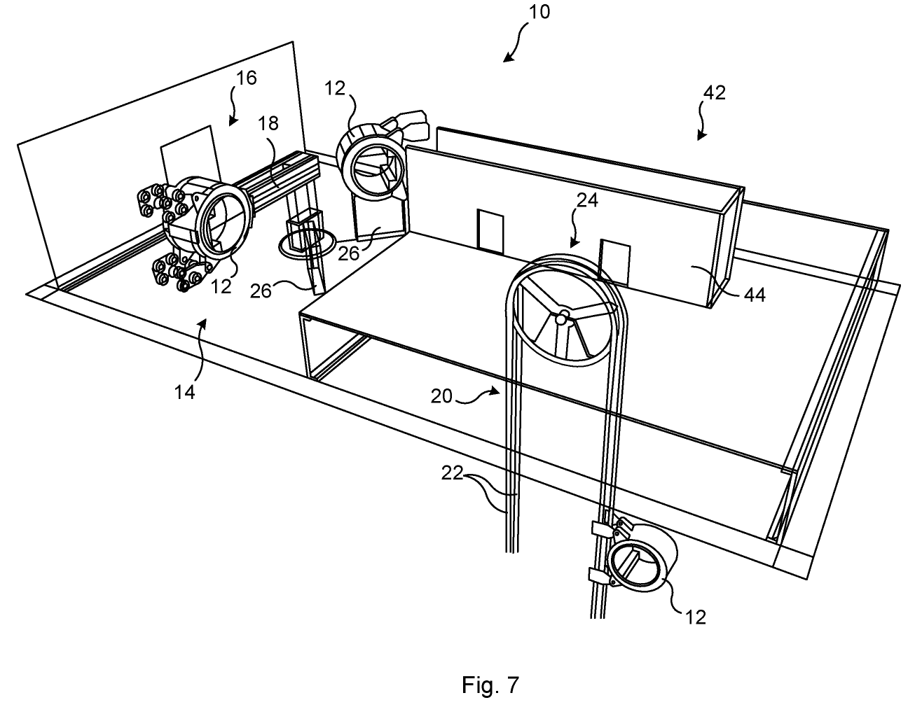

FIG. 7 schematically represents an elevator system 42 in a building comprising an arrangement 10 of the type in FIG. 1. The arrangement 10 comprises a storage area 14 with two storage positions 26 (one occupied) and a transfer mechanism 16 in the form of a robot 18. An upper station 44 along the operational path 20 can be seen in FIG. 7.

The robot 18 comprises a telescoping arm such that the arm can enter a space between two vertical walls of the station 44 to grab or release a carriage 12 in the operational position 24. Once a carriage 12 is grabbed at the operational position 24, the carriage 12 is disengaged from the rails 22 (e.g. by the openable wheel assemblies) and the arm with the carriage 12 is retracted towards the base of the robot 18. The robot 18 is then rotated (the arm may also be extended) to position the carriage 12 on any vacant storage position 26. A reverse procedure may be carried out for placing any of the carriages 12 within the storage area 14 back in the operational position 24 along the operational path 20.

As can be seen in FIG. 7, the arrangement 10 partly occupies two floor levels of the building since the storage area 14 is provided on a floor level below the floor level of the station 44. However, the floor level may be provided at the same height as the floor level of the station 44.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. Arrangement for handling carriages in an elevator system, the arrangement comprising:
at least one carriage;
a storage area adjacent to an operational path of the elevator system for storage, service and/or maintenance of the at least one carriage; and
a transfer mechanism for transferring the carriage between an operational position along the operational path and at least one storage position within the storage area; wherein the carriage comprises at least one openable wheel assembly that in an open state enables the carriage to be lifted off a track by a robot and in a closed state locks the carriage to the track for relative movement thereon.

2. The arrangement according to claim 1, wherein the transfer mechanism comprises a robot for moving the carriage to and from the storage position.

3. The arrangement according to claim 2, wherein the robot is configured to move the carriage between the operational position and the storage position.

4. The arrangement according to claim 1, wherein the transfer mechanism comprises a track section for guiding the carriage between the operational position and the storage position.

5. The arrangement according to claim 4, wherein the track section comprises a turntable.

6. The arrangement according to claim 4, wherein at least a part of the track section is movable between a switching state for guiding the carriage to the storage position and an operational state where the track section forms a part of the operational path.

7. The arrangement according to claim 2, wherein the transfer mechanism comprises a track section for guiding the carriage to an intermediate position from which the robot can move the carriage to and from the storage position.

8. The arrangement according to claim 7, wherein at least a part of the track section is movable between a switching state constituting the intermediate position or for guiding the carriage to the intermediate position and an operational state where the track section forms a part of the operational path.

9. Elevator system comprising an arrangement according to claim 1.

10. (canceled)

11. The arrangement according to claim 5, wherein at least a part of the track section is movable between a switching state for guiding the carriage to the storage position and an operational state where the track section forms a part of the operational path.
